(19) United States
(12) Patent Application Publication
(10) Pub. No.: US 2007/0293109 A1
(43) Pub. Date: Dec. 20, 2007

(54) Composite material for stab, ice pick and armor applications

(76) Inventors: Ashok Bhatnagar, Richmond, VA (US); Harold Lindley Murray JR., North East, MD (US); Lori L. Wagner, Richmond, VA (US)

Correspondence Address: Honeywell International Inc., 15801 Woods Edge Road, Colonial Heights, VA, 23834, US

(21) Appl. No.: 11/154,454

(22) Filed: Jun. 16, 2005

(51) Int. Cl. D03D 15/12; B32B 27/12; B32B 5/26; B32B 15/14

(52) U.S. Cl. 442/239; 442/286; 442/301; 442/302; 442/232; 442/234; 442/396; 442/378; 442/414; 442/381

(57) ABSTRACT

Impact resistant composites formed from at least one fibrous layer comprising a network of high tenacity fibers and at least one layer of a thin titanium film the composite being resistant to at least one of knife stabs, ice pick stabs and ballistic projectiles. Preferably there are a plurality of such layers and the titanium film layer is disposed between adjacent fibrous layers. Body armor formed from the composites have the desired resistance to knife stabs, ice pick stabs and ballistic projectiles.

### BACKGROUND OF THE INVENTION

1. Field of the Invention

This invention relates to composite materials which incorporate high strength fibers and are useful in various applications, especially for stab protection, ice pick protection and ballistic projectile protection in body armor applications and the like.

2. Description of the Related Art

Ballistic resistant products for vests and the like are known in the art. Many of these products are based on high tenacity fibers, such as extended chain polyethylene fibers. Body armor, such as bullet-resistant vests, may be formed from rigid composites and/or flexible composites.

Rigid body armor provides good resistance to puncture by sharp objects, such as knife blades, but they are also very stiff and relatively bulky. As a result, in general rigid body armor garments (e.g., vests) are less comfortable to wear than flexible body armor garments. However, the latter may not provide adequate resistance to knife stabs, ice pick stabs and the like.

It would be desirable to provide a composite material which is resistant to knife stabs, ice picks and/or ballistic projectiles so as to provide protection to the wearer. It would also be desirable to provide a body armor which was resistant to sharp knives, ice picks and/or ballistic projectiles. The body armor may be flexible to provide comfort or rigid and yet not too heavy as would be experienced with a thick metal plate or the like. Such armor desirably would be comfortable to wear and not costly to manufacture.

### SUMMARY OF THE INVENTION

In accordance with this invention, there is provided an impact resistant composite, comprising:

(a) at least one fibrous layer, the fibrous layer comprising a network of high tenacity fibers, and

(b) at least one layer of a thin titanium film, the composite being resistant to at least one of knife stabs, ice pick stabs and ballistic projectiles.

Further in accordance with this invention, there is provided an impact resistant composite, comprising:

(a) a plurality of fibrous layers, each of the fibrous layers comprising a network of high tenacity fibers, and

(b) at least one layer of a thin titanium film, the titanium film being disposed between at least two adjacent fibrous layers, the composite being resistant to at least one of knife stabs, ice pick stabs and ballistic projectiles.

Also in accordance with this invention, there is provided body armor which is resistant to at least one of knife stabs, ice pick stabs and ballistic projectiles, the body armor comprising at least one composite, the composite comprising:

(a) at least one fibrous layer, the fibrous layer comprising a network of high tenacity fibers, and

(b) at least one layer of a thin titanium film.

In addition, this invention provides body armor which is resistant to at least one of knife stabs, ice pick stabs and ballistic projectiles, the body armor comprising at least one composite, the composite comprising:

(a) a plurality of fibrous layers, each of the fibrous layers comprising a network of high tenacity fibers, and

(b) at least one layer of a thin titanium film, the titanium film being disposed between at least two adjacent fibrous layers.

The present invention provides a composite material which is based on a reinforced titanium film. It has been found that a construction which incorporates such reinforced titanium film composites provides excellent resistance to knife stabs, ice pick stabs and ballistic projectiles. Body armor formed from the composite material is comfortable to wear and can be manufactured in a cost-effective manner.

In addition, the composite of this invention and body armor made therefrom do not have a metallic feel or sound that is characteristic of structures that include thick metal layers that are not reinforced with high tenacity fibers as in the present invention. This feature adds to the desirable feel and comfort of the products of this invention.

### DETAILED DESCRIPTION OF THE INVENTION

The present invention comprises a composite which comprises a thin titanium film reinforced with high tenacity fibers. The composite is formed from at least one layer of thin titanium film and at least one layer comprising high tenacity fibers. For the purposes of the present invention, a fiber is an elongate body the length dimension of which is much greater that the transverse dimensions of width and thickness. Accordingly, the term fiber includes filament, ribbon, strip, and the like having regular or irregular cross-section. A yarn is a continuous strand comprised of many fibers or filaments.

As used herein, the term “high tenacity fibers” means fibers which have tenacity's equal to or greater than about 7 g/d. Preferably, these fibers have initial tensile moduli of at least about 150 g/d and energies-to-break of at least about 8 J/g as measured by ASTM D2256. As used herein, the terms “initial tensile modulus”. “tensile modulus” and “modulus” mean the modulus of elasticity as measured by ASTM 2256 for a yarn and by ASTM D638 for in elastomer or matrix material.

Preferably, the high tenacity fibers have tenacities equal to or greater than about 10 g/d, more preferably equal to or greater than about 16 g/d, even more preferably equal to or greater than about 22 g/d, and most preferably equal to or greater than about 28 g/d.

The network of fibers used in the composite of this invention may be in the form of woven, knitted or non-woven fabrics formed from high tenacity fibers. Preferably, at least 50% by weight of the fibers in the fabric are high tenacity fibers, more preferably at least about 75% by weight of the fibers in the fabric are high tenacity fibers, and most preferably substantially all of the fibers in the fabric are high tenacity fibers.

The yarns and fabrics of the invention may be comprised of one or more different high strength fibers. The yarns may be in essentially parallel alignment, or the yarns may be twisted, over-wrapped or entangled. The fabrics of the invention may be woven with yarns having different fibers in the warp and weft directions, or in other directions.

High strength fibers useful in the yarns and fabrics of the invention include highly oriented high molecular weight polyolefin fibers, particularly high modulus polyethylene fibers, aramid fibers, polybenzazole fibers such as polybenzoxazole (PBO) and polybenzothiazole (PBT), polyvinyl alcohol fibers. polyacrylonitrile fibers, liquid crystal copolyester fibers, glass fibers, carbon fibers or basalt or other mineral fibers, as well as rigid rod polymer fibers, and mixtures and blends thereof. Preferred high strength fibers useful in this invention include polyolefin fibers, aramid fibers and polybenzazole fibers, and mixtures and blends thereof. Most preferred are high molecular weight polyethylene fibers.

U.S. Pat. No. 4,457,985 generally discusses such high molecular weight polyethylene and polypropylene fibers, and the disclosure of this patent is hereby incorporated by reference to the extent that it is not inconsistent herewith. In the case of polyethylene, suitable fibers are those of weight average molecular weight of at least about 150,000, preferably at least about one million and more preferably between about two million and about five million. Such high molecular weight polyethylene fibers may be spun in solution (see U.S. Pat. No. 4,137,394 and U.S. Pat. No. 4,356,138), or a filament spun from a solution to form a gel structure (see U.S. Pat. No. 4,413,110, German Off. No. 3,004, 699 and GB Patent No. 2051667), or the polyethylene fibers may be produced by a rolling and drawing process (see U.S. Pat. No. 5,702,657). As used herein, the term polyethylene means a predominantly linear polyethylene material that may contain minor amounts of chain branching or comonomers not exceeding 5 modifying units per 100 main chain carbon atoms, and that may also contain admixed therewith not more than about 50 wt % of one or more polymeric additives such as alkene-1-polymers, in particular low density polyethylene, polypropylene or polybutylene, copolymers containing mono-olefins as primary monomers, oxidized polyolefins, graft polyolefin copolymers and polyoxymethylenes, or low molecular weight additives such as antioxidants, lubricants, ultraviolet screening agents, colorants and the like which are commonly incorporated.

High tenacity polyethylene fibers (also referred to as extended chain or high molecular weight polyethylene fibers) are preferred and are sold under the trademark SPECTRA® by Honeywell International Inc. of Morristown, N.J.

Depending upon the formation technique, the draw ratio and temperatures, and other conditions, a variety of properties can be imparted to these fibers. The tenacity of the polyethylene fibers are at least about 7 g/d, preferably at least about 15 g/d, more preferably at least about 20 g/d, still more preferably at least about 25 g/d and most preferably at least about 30 g/d. Similarly, the initial tensile modulus of the fibers, as measured by an Instron tensile testing machine, is preferably at least about 300 g/d, more preferably at least about 500 g/d, still more preferably at least about 1,000 g/d and most preferably at least about 1,200 g/d. These highest values for initial tensile modulus and tenacity are generally obtainable only by employing solution grown or gel spinning processes. Many of the filaments have melting points higher than the melting point of the polymer from which they were formed. Thus, for example, high molecular weight polyethylene of about 150,000, about one million and about two million molecular weight generally have melting points in the bulk of 138° C. The highly oriented polyethylene filaments made of these materials have melting points of from about 7° C. to about 13° C. higher. Thus, a slight increase in melting point reflects the crystalline perfection and higher crystalline orientation of the filaments as compared to the bulk polymer.

Similarly, highly oriented high molecular weight polypropylene fibers of weight average molecular weight at least about 200,000, preferably at least about one million and more preferably at least about two million may be used. Such extended chain polypropylene may be formed into reasonably well-oriented filaments by the techniques prescribed in the various references referred to above, and especially by the technique of U.S. Pat. No. 4,413,110. Since polypropylene is a much less crystalline material than polyethylene and contains pendant methyl groups, tenacity values achievable with polypropylene are generally substantially lower than the corresponding values for polyethylene. Accordingly, a suitable tenacity is preferably at least about 8 g/d, more preferably at least about 11 g/d. The initial tensile modulus for polypropylene is preferably at least about 160 g/d, more preferably at least about 200 g/d. The melting point of the polypropylene is generally raised several degrees by the orientation process, such that the polypropylene filament preferably has a main melting point of at least 168° C., more preferably at least 170° C. The particularly preferred ranges for the above described parameters can advantageously provide improved performance in the final article. Employing fibers having a weight average molecular weight of at least about 200,000 coupled with the preferred ranges for the above-described parameters (modulus and tenacity) can provide advantageously improved performance in the final article.

In the case of aramid fibers, suitable fibers formed from aromatic polyamides are described in U.S. Pat. No. 3,671,542, which is incorporated herein by reference to the extent not inconsistent herewith. Preferred aramid fibers will have a tenacity of at least about 20 g/d, an initial tensile modulus of at least about 400 g/d and an energy-to-break at least about 8 J/g, and particularly preferred aramid fibers will have a tenacity of at least about 20 g/d and an energy-to-break of at least about 20 J/g. Most preferred aramid fibers will have a tenacity of at least about 20 g/d, a modulus of at least about 900 g/d and an energy-to-break of at least about 30 J/g. For example, poly(p-phenylene terephthalamide) filaments which have moderately high moduli and tenacity values are particularly useful in forming ballistic resistant composites. Examples are Kevlar® 29 which has 500 g/d and 22 g/d as values of initial tensile modulus and tenacity, respectively, as well as Kevlar® 129 and KM2 which are available in 400, 640 and 840 deniers. Aramid fibers from other manufacturers can also be used in this invention. Also useful in the practice of this invention are poly(m-phenylene isophthalamide) fibers produced commercially by du Pont under the trade name Nomex®.

High molecular weight polyvinyl alcohol (PV-OH) fibers having high tensile modulus are described in U.S. Pat. No. 4,440,711 to Kwon et al., which is hereby incorporated by reference to the extent it is not inconsistent herewith. High molecular weight PV-OH fibers should have a weight average molecular weight of at least about 200,000. Particularly useful PV-OH fibers should have a modulus of at least about 300 g/d, a tenacity preferably at least about 10 g/d. more preferably at least about 14 g/d and most preferably at least about 17 g/d, and an energy to break of at least about 8 J/g. PV-OH fiber having such properties can be produced, for example, by the process disclosed in U.S. Pat. No. 4,599,267.

In the case of polyacrylonitrile (PAN), the PAN fiber should have a weight average molecular weight of at least about 400,000. Particularly useful PAN fiber should have a tenacity of preferably at least about 10 g/d and an energy to break of at least about 8 J/g. PAN fiber having a molecular weight of at least about 400,000, a tenacity of at least about 15 to 20 g/d and an energy to break of at least about 8 J/g is most useful; and such fibers are disclosed, for example, in U.S. Pat. No. 4,535,027.

Suitable liquid crystal copolyester fibers for the practice of this invention are disclosed, for example, in U.S. Pat. Nos. 3,975,487; 4,118,372 and 4,161,470.

Suitable polybenzazole fibers for the practice of this invention are disclosed, for example, in U.S. Pat. Nos. 5,286,833, 5,296,185, 5,356,584, 5,534,205 and 6,040,050. Preferably, the polybenzazole fibers are Zylon® brand fibers from Toyobo Co.

Rigid rod fibers are disclosed, for example, in U.S. Pat. Nos. 5,674,969, 5,939,553, 5,945,537 and 6,040,478. Such fibers are available under the designation M5® fibers from Magellan Systems International.

As mentioned above, the high strength fibers may be in the form of a woven, knitted or non-woven fabric. One preferred material is a woven fabric formed from SPECTRA® polyethylene fibers. In one embodiment, the fabric preferably has between about 15 and about 55 ends per inch (about 5.9 to about 21.6 ends per cm) in both the warp and fill directions, and more preferably between about 17 and about 45 ends per inch (about 6.7 to about 17.7 ends per cm). The yarns are preferably each between about 200 and about 1200 denier. The result is a woven fabric weighing preferably between about 2 and about 15 ounces per square yard (about 67.8 to about 508.6 g/m²), and more preferably between about 5 and about 11 ounces per square yard (about 169.5 to about 373.0 g/m²). Examples of such fabrics are those designated as SPECTRA® fabric styles 902, 904, 952, 955 and 960. As those skilled in the art will appreciate, the fabric constructions described here are exemplary only and not intended to limit the invention thereto.

The high strength fabric may be in the form of a non-woven fabric, such as plies of unidirectionally oriented fibers, or fibers which are felted in a random orientation, which are embedded in a suitable resin matrix, as is known in the art. Another preferred fabric material useful herein as the fibrous layer(s) are fabrics formed from unidirectionally oriented fibers, which typically have one layer of fibers which extend in one direction and a second layer of fibers which extend in a direction 90° from the first fibers. Where the individual plies are unidirectionally oriented fibers, the successive plies are preferably rotated relative to one another, for example at angles of 0°/90° or 0°/45°/90°/45°/0° or at other angles. Examples of these unidirectionally oriented non-woven fabrics are the following, all of which are available from Honeywell International Inc.: SPECTRA SHIELD® PCR (which is a non-woven fabric of SPECTRA® extended-chain polyethylene fiber tapes including a resin, which tapes are cross-plied at 0°/90° and are usually used in hard armor applications), SPECTRA SHIELD® PLUS PCR (which is a lighter version of SPECTRA SHIELD® PCR fabric), SPECTRA SHIELD® LCR (which is a non-woven fabric of SPECTRA® extended-chain polyethylene fiber tapes including a resin, which tapes are cross-plied at 0°/90°, sandwiched with a thermoplastic film, and are usually used in soft armor applications), SPECTRA SHIELD® PLUS LCR (which is a lighter version of SPECTRA SHIELD® LCR fabric), and GOLD FLEX® (which is an aramid shield material of four plies of unidirectional aramid fiber tapes including a resin, which are cross-plied at 0°/90°, 0°/90°, and sandwiched with a thermoplastic film).

The resin matrix for the unidirectionally oriented fiber plies may be formed from a wide variety of elastomeric materials having desired characteristics. In one embodiment, the elastomeric materials used in such matrix possess initial tensile modulus (modulus of elasticity) equal to or less than about 6,000 psi (41.4 MPa) as measured by ASTM D638. More preferably, the elastomer has initial tensile modulus equal to or less than about 2,400 psi (16.5 MPa). Most preferably, the elastomeric material has initial tensile modulus equal to or less than about 1,200 psi (8.23 MPa). These resinous materials are typically thermoplastic in nature.

Alternatively, the resin matrix may be selected to have a high tensile modulus when cured, as at least about 1×10⁶ psi (6895 MPa). Examples of such materials are disclosed, for example, in U.S. Pat. No. 6,642,159, the disclosure of which is expressly incorporated herein by reference.

The proportion of the resin matrix material to fiber in the composite layers may vary widely depending upon the end use. The elastomeric material preferably forms about 1 to about 98 percent by weight, more preferably from about 10 to about 95 percent by weight, of the unidirectionally oriented fiber plies.

A wide variety of elastomeric materials may be utilized as the resin matrix. For example, any of the following materials may be employed: polybutadiene, polyisoprene, natural rubber, ethylene-propylene copolymers, ethylene-propylene-diene terpolymers, polysulfide polymers, polyurethane elastomers, chlorosulfonated polyethylene, polychloroprene, plasticized polyvinylchloride using dioctyl phthalate or other plasticizers well known in the art, butadiene acrylonitrile elastomers, poly (isobutylene-co-isoprene), polyacrylates, polyesters, polyethers, fluoroelastomers, silicone elastomers, thermoplastic elastomers, and copolymers of ethylene. Examples of thermosetting resins include those which are soluble in carbon-carbon saturated solvents such as methyl ethyl ketone, acetone, ethanol, methanol, isopropyl alcohol, cyclohexane, ethyl acetone, and combinations thereof. Among the thermosetting resins are vinyl esters, styrene-butadiene block copolymers, diallyl phthalate, phenol formaldehyde, polyvinyl butyral and mixtures thereof, as disclosed in the aforementioned U.S. Pat. No. 6,642,159. Preferred thermosetting resins for polyethylene fiber fabrics include at least one vinyl ester, diallyl phthalate, and optionally a catalyst for curing the vinyl ester resin.

One preferred group of materials for polyethylene fiber fabrics are block copolymers of conjugated dienes and vinyl aromatic copolymers. Butadiene and isoprene are preferred conjugated diene elastomers. Styrene, vinyl toluene and t-butyl styrene are preferred conjugated aromatic monomers. Block copolymers incorporating polyisoprene may be hydrogenated to produce thermoplastic elastomers having saturated hydrocarbon elastomer segments. The polymers may be simple tri-block copolymers of the type R—(BA)ₓ (x=3-150); wherein A is a block from a polyvinyl aromatic monomer and B is a block from a conjugated diene elastomer.

The high tenacity unidirectional fibrous layers may be impregnated with or embedded in the chosen matrix resin by applying the matrix composition to the fibers and then consolidating the matrix composition/high tenacity fibers in a known manner. By “consolidating” is meant that the matrix material and the fiber network layer are combined into a single unitary layer. Consolidation cam occur via drying, cooling, heating, pressure or a combination thereof.

The titanium film used in this invention is in the form of a thin film. By “thin film” it is meant that the thickness of the film is equal to or less than about 1 mm. For example, the titanium film may have a thickness in the range of from about 0.01 to about 0.5 mm, more preferably from about 0.05 to about 0.35 mm, and most preferably from about 0.1 to about 0.2 mm. One preferred film is a 0.127 mm titanium film available from Deutsche Titan of Germany

One or more titanium film layers are arranged with and preferably laminated to one or more layers that comprise high tenacity fibers. Any suitable adhesive system and lamination method can be used. For example, the adhesive can be sprayed on one or both sides of the titanium film. Preferably, the film is cleaned with a material such as acetone or another cleaning agent prior to the application of adhesive. Examples of adhesives that may be employed in this invention include thermoplastic and thermosetting adhesives, either in resin or cast film form.

One or more plastic films can be included in the composite to permit different composite layers to slide over each other for ease of forming into a body shape and ease of wearing. Any suitable plastic film may be employed, such as films made of polyolefins. Examples of such films are linear low density polyethylene (LLDPE) films, ultrahigh molecular weight polyethylene (UHMWPE) films, polyester films, nylon films, polycarbonate films and the like. These films may be of any desirable thickness. Typical thickness range from about 0.1 to about 1.2 mils (2.5 to 30 μm), more preferably from about 0.2 to about 1 mil (5 to 25 μm), and most preferably from about 0.3 to about 0.5 mils (7.5 to 12.5 μm).

The composite layers of this invention may be formed in any suitable manner. For example, the adhesive may be sprayed onto both sides of the thin titanium film, a reinforcing layer is provided on one (preferably both) sides of the titanium film, and a LLDPE film is applied on one (preferably both) sides of the adhesively coated titanium film. The composite is then molded under heat and pressure to consolidate the composite, in a maimer known in the art. For example, pressures may range from about 1 to about 250 psi (6.9 to 1725 kPa). Temperatures may range from about 75 to about 260° F. (24 to 127° C.). Molding times may range, for example, from about 1 to about 30 minutes.

In one embodiment of this invention, the body armor is resistant to ballistic projectiles. In this embodiment, a ballistically resistant composite comprising a network of high tenacity fibers is present. These fibers may be in a matrix of a low modulus material. In general, those fibers which are discussed above with respect to the knife-stab resistant layer are suitable for use in the ballistic-resistant layer. Preferably at least 50 percent by weight of the fibers in the ballistically resistant composite comprise the high tenacity fibers, and more preferably at least 75 percent by weight of the fibers in such composite comprise the high tenacity fibers. It should be noted that the same or different high tenacity fibers may be used in the knife-stab resistant layer and the ballistic-resistant layer.

Various constructions are known for fiber-reinforced composites used in impact and ballistic resistant articles such as helmets, panels, and vests. These composites display varying degrees of resistance to penetration by high speed impact from projectiles such as bullets, shrapnel and fragments, and the like. For example, U.S. Pat. Nos. 6,268,301 B1, 6,248,676 B1, 6,219,842 B1; 5,677,029, 5,587,230; 5,552,208; 5,471,906; 5,330,820; 5,196,252; 5,190,802; 5,187,023; 5,185,195; 5,175,040; 5,167,876; 5,165,989; 5,124,195; 5,112,667; 5,061,545; 5,006,390; 4,953,234; 4,916,000; 4,883,700; 4,820,568; 4,748,064; 4,737,402; 4,737,401; 4,681,792; 4,650,710; 4,623,574; 4,613,535; 4,584,347; 4,563,392; 4,543,286; 4,501,856; 4,457,985; and 4,403,012; PCT Publication No. WO 91/12136; and a 1984 publication of E.I. DuPont De Nemours International S.A. entitled “Lightweight Composite Hard Armor Non Apparel Systems with T-963 3300 dtex DuPont Kevlar 29 Fibre”, all describe ballistic resistant composites which include high strength fibers made from materials such as high molecular weight polyethylene, aramids and polybenzazoles. Such composites are said to be either flexible or rigid depending on the nature of their construction and the materials employed.

Ballistically resistant composites are typically formed from woven or knitted fabrics or sheets of fibers which are plied together. The fibers in a sheet may be unidirectionally oriented, with two layers of such unidirectionally oriented fibers cross-plied in a 0°/90° arrangement or felted in random orientation. Where the individual plies are unidirectionally oriented fibers, the successive plies are preferably rotated relative to one another, for example at angles of 0°/90° or 0°/45°/90°/45°/0° or at other angles. The individual plies of woven fabrics or fibers are either uncoated or embedded in a polymeric matrix material which fills the void spaces between the fibers. If no matrix is present, the fabric or fiber sheet is inherently flexible, and if a matrix is used it is preferably a flexible ore. Preferably, the ballistic resistant layers of this invention are fabrics formed from polyethylene or aramid fibers. As is known in the art, typically several layers of the ballistic-resistant composite are employed in the body armor to provide the requisite ballistic resistance, and the individual layers may be formed from different fibers or be in a different configuration than an adjacent layer.

The fabric portion of the ballistically-resistant layers may be a woven fabric that may be of any weave pattern, including plain weave, twill, satin, three dimensional woven fabrics, and any of their several variations. Plain weave fabrics are preferred and more preferred are plain weave fabrics having an equal warp and weft count.

It will be understood to those skilled in the art that it is not presently possible to specify a priori the best weave count for any particular combination of material, fiber denier and yarn denier. On the one hand, tighter weaves having the highest possible coverage make it more difficult for the projectile to find holes and to push yarns and fibers aside. On the other hand, high frequency of yarn cross-overs restricts propagation of the ballistic event through the fabric and lessens the volume of fibers able to absorb energy from the projectile. The skilled artisan will readily find the best yarn count for each fiber material, yarn denier and filament denier by experimentation.

The yarns of the laminates useful in the ballistic resistant layers may be from about 50 denier to about 3000 denier. The selection is governed by considerations of ballistic effectiveness and cost. Finer yarns are more costly to manufacture and to weave, but can produce greater ballistic effectiveness per unit weight. The yarns are preferably from about 200 denier to about 3000 denier. More preferably, the yarns are from about 650 denier to about 1500 denier. Most preferably, the yarns are from about 800 denier to about 1500 denier.

The cross-sections of fibers useful herein may vary widely. They may be circular, flat or oblong in cross-section. They may also be of irregular or regular multi-lobal cross-section having one or more regular or irregular lobes projecting from the linear or longitudinal axis of the fibers. It is preferred that the fibers be of substantially circular, flat or oblong cross-section, most preferably the former.

In one embodiment, a vest is formed in a conventional manner from a plurality of layers of the composites. These layers preferably are not laminated together but usually loosely arranged in a pillow or the like. It may be desirable to stitch the layers together to avoid slippage of the individual plies with respect to each other. Alternatively, they could be laminated to one another. To provide the desired resistance to knife stabs, ice pick stabs and/or ballistic projectiles, the layers incorporating the thin titanium film are preferably arranged such that these layers are located towards the exterior of the vest or other body armor, thus facing outwardly of the wearer.

The composites of this invention and the body armor formed therefrom are preferably flexible materials, although they could also be in the form of semi-rigid or rigid materials, depending on the type of resin and system used. By selecting an appropriate design of the composites and body armor, one skilled in the art can readily achieve structures which are resistant to knife stabs, resistant to ice pick stabs, resistant to ballistic projectiles, resistant to two of such threats or resistant to all three threats.

The following non-limiting examples are presented to provide a more complete understanding of the invention. The specific techniques, conditions, materials, proportions and reported data set forth to illustrate the principles of the invention are exemplary and should not be construed as limiting the scope of tile invention.

### EXAMPLES

### Example 1

A composite which is ballistic resistant was formed from a structure which included layers of unidirectionally oriented extended-chain polyethylene fibers and titanium film. The composite was formed from SPECTRA SHIELD® PLUS PCR layers and layers of a 0.127 mm thick titanium film available from Deutsche Titan of Germany. The construction was one layer of SPECTRA SHIELD® PLUS PCR, one layer of titanium film, 4 layers of SPECTRA SHIELD® PLUS PCR, one layer of titanium film, and 36 layers of SPECTRA SHIELD® PLUS PCR. The extended-chain polyethylene fiber layers were adhered to the titanium film layer by an adhesive (Super 77, a general spray adhesive available from 3M. The SPECTRA SHIELD® PLUS PCR layers were formed from SPECTRA® 1000 polyethylene yarns having 1100 denier, available from Honeywell International Inc. These yarns had tensile properties of 36 g/d tenacity and 1250 g/d modulus. Panels of 12×12 inches (30.5×30.5 cm) were formed, which had a thickness of 0.210 inches (5.334 mm) and a weight of 459 grams.

The panels were tested for ballistic fragment protection per test method MIL-STD-662F, and the fragments used conformed to MIL-P-46593A. These fragments were 17 grain, 22 caliber, FSP hardened fragment simulators. One measure of the protective power of a sample composite is expressed by citing the impacting velocity at which 50% of the projectiles are stopped. This velocity, expressed in units of feet per second, is designated the V₅₀.

The results for the 17 grain FSP were V₅₀=1768 fps.

### Example 2

Panels were produced in a manner similar to that of Example 1 and tested for rifle bullet protection. The panel size was the same as in Example 1. The construction of the composite was as follows: 1 layer of SPECTRA SHIELD® PLUS PCR, 1 layer of titanium film, 4 layers of SPECTRA SHIELD® PLUS PCR, 1 layer of titanium film, 4 layers of SPECTRA SHIELD® PLUS PCR, 1 layer of titanium film, 4 layers of SPECTRA SHIELD® PLUS PCR, 1 layer of titanium film, 4 layers of SPECTRA SHIELD® PLUS PCR, 1 layer of titanium film, and 139 layers of SPECTRA SHIELD® PLUS PCR. The panels had a weight of 3.59 pounds (1.63 kg) and a thickness of 0.689 inches (1.750 cm).

The panels were tested in accordance with test method MIL-STD-662F, with a bullet that was a M80 ball, 7.62×51 mm. The result was a V₅₀ of 2585 fps.

### Example 3

Panels were produced and tested for ice pick protection. The panels were formed from 4 layers of a reinforced titanium composite and 30 layers of GOLD FLEX® non-woven aramid fabric. The reinforced titanium composite (referred to herein as RT1) had dimensions of 8×8 inches (20.3×20.3 cm) was a structure of linear low density polyethylene (LLDPE) film/SPECTRA® fabric style 955 woven fabric/adhesive/titanium film/adhesive/SPECTRA® fabric style 955 woven fabric/LLDPE film. The LLDPE film has a thickness of 0.35 mils (8.75 μm). The RT1 composite was formed by spraying a thin layer of Super 77 adhesive from 3M on both sides of the titanium film, adding the reinforcing layers to the adhesive coated sides of the titanium film, applying the LLDPE film over the reinforcing layers, and molding at 240° F. (115.6° C.) at 200 psi (1375 kPa) for 30 minutes. The GOLD FLEX® non-woven aramid fabric had dimensions of 18×18 inches (45.7×45.7 cm).

The panels were tested for ice pick protection in accordance with the NIJ Stab Resistance of Personal Body Armor test standard NIJ-STD-0115.00, with the titanium film layers facing outwards. The results are shown in Table 1.

### Example 4

Example 3 was repeated, except that an alternate reinforced titanium composite was used. This composite (designated RT2) was a non-woven fibrous structure which had a construction of LLDPE film/SPECTRA SHIELD® PLUS PCR/adhesive/titanium film/SPECTRA SHIELD® PLUS PCR/LLDPE film. The dimensions of the RT2 structure were the same as in Example 3 and the RT-2 structure was formed in a similar manner as the RT1 structure. In this example 30 layers of GOLD FLEX® non-woven fabric were also used, of the same dimensions as in Example 3.

The panels were also tested for ice pick protection in accordance with the NIJ Stab Resistance of Personal Body Armor test standard NIJ-STD-0115.00, with the titanium film layers facing outwards. The results are also shown in Table 1.

### Example 5

In this example, a composite was formed from 4 layers of titanium film of 8×8 inches (20.3×20.3 cm) in dimension and 30 layers of GOLD FLEX® non-woven aramid fabric of 18×18 inches (45.7×45.7 cm) in dimension. The titanium film layers were stacked together, as were the GOLD FLEX® layers.

The panels were also tested for ice pick protection in accordance with the NIJ Stab Resistance of Personal Body Armor test standard NIJ-STD-0115.00, with the titanium film layers facing outwards. The results are also shown in Table 1.

### Example 6 (Comparative)

Example 3 was repeated, except that the composite was formed with 30 layers of GOLD FLEX® non-woven aramid fabric of the same dimensions as Example 3, and without any titanium film.

The panels were also tested for ice pick protection in accordance with the NIJ Stab Resistance of Personal Body Armor test standard NIJ-STD-0115.00. The results are also shown in Table 1.

### Example 7 (Comparative)

Example 3 was repeated, except that the composite was formed with 43 layers of GOLD FLEX® non-woven aramid fabric, and without any titanium film.

The panels were also tested for ice pick protection in accordance with the NIJ Stab Resistance of Personal Body Armor test standard NIJ-STD-0115.00. The results are also shown in Table 1.

TABLE 1

| Example | System Weight | Thickness | Impact | |
|---|---|---|---|---|
| Penetration | (psf) | (inches) | Energy (j) | (mm) |
| 3 | 2.06 | 0.330 | 36.16 | 22 |
| 4 | 2.02 | 0.334 | 36.16 | 18 |
| 5 | 1.81 | 0.282 | 35.94 | 17 |
| 6 (comparative) | 1.42 | 0.265 | 35.87 | 43 |
| 7 (comparative) | 2.04 | 0.423 | 36.10 | 30 |

The above examples demonstrate the spike (ice-pick) protection performance as per energy level E2 and protection level 1, specified by the NIJ standard 0115.00 for flexible vest constructions. It can be seen that typical vest constructions (Comparative Examples 6 and 7) with only high tenacity fiber layers (30 and 43, respectively) have good ballistic resistance but poor spike resistance. With the addition of a limited number (4) of thin film titanium layers a vest material with 30 layers (Example 5) achieved the desired performance (penetration under 20 mm) and pass the test. It can also be seen that the addition of a limited number (4) of reinforced thin film titanium layers (RT1) containing woven high tenacity polyethylene fibers to a 30 layer vest material significantly reduced the penetration distance (Example 3). Moreover, the addition of 4 layers of reinforced thin film titanium which contained non-woven high tenacity polyethylene fibers to a 30 layer vest material (Example 4) further reduced the penetration so as to conform with the standard.

### Example 8

Panels of the same size as in Example 4 were produced and tested for knife stab protection. The panels were formed from 5 layers of reinforced titanium composite RT1 and 19 layers of GOLD FLEX® non-woven aramid fabric that were stacked together. The reinforced titanium layers faced outwardly.

The panels were tested for knife-blade stab resistance in accordance with the NIJ Stab Resistance of Personal Body Armor NIJ Standard 0115.00, using a P1 knife (having a blade of about 1/16 inch (1.59 mm) thick with one cutting edge).

The results are shown in Table 2 below.

### Example 9

Panels of the same size as in Example 3 were produced and tested for knife stab protection. The panels were formed from 5 layers of reinforced titanium composite RT2 and 19 layers of GOLD FLEX® non-woven aramid fabric. The layers were stacked together, with the reinforced titanium layers facing outwardly.

The panels were tested for knife-blade stab resistance in accordance with the NIJ Stab Resistance of Personal Body Armor NIJ Standard 0115.00, using a P1 knife.

The results are also shown in Table 2 below.

### Example 10

Panels of the same size as in Example 3 were produced and tested for knife stab protection. The panels were formed from 9 layers of reinforced titanium composite RT1.

The panels were tested for knife-blade stab resistance in accordance with the NIJ Stab Resistance of Personal Body Armor NIJ Standard 0115.00, using a P1 knife.

The results are also shown in Table 2 below.

### Example 11

Panels of the same size as in Example 3 were produced and tested for knife stab protection. The panels were formed from 3 layers of reinforced titanium composite RT1.

The panels were tested for knife-blade stab resistance in accordance with the NIJ Stab Resistance of Personal Body Armor NIJ Standard 0115.00, using a P1 knife.

The results are shown in Table 2 below.

### Example 12

Panels of the same size as in Example 3 were produced and tested for knife stab protection. The panels were formed from 5 layers of a thin titanium film (0.127 mm thickness from Deutsche Titan) and 19 layers of GOLD FLEX® non-woven aramid fabric that were stacked together, with the titanium layers facing outwardly.

The panels were tested for knife-blade stab resistance in accordance with the NIJ Stab Resistance of Personal Body Armor NIJ Standard 0115.00, using a P1 knife, and the results are also shown in Table 2 below.

### Example 13 (Comparative)

Panels of the same size as in Example 3 were produced and tested for knife stab protection. The panels were formed only with 30 layers of GOLD FLEX® non-woven aramid fabric, and without any titanium film.

The panels were tested for knife-blade stab resistance in accordance with the NIJ Stab Resistance of Personal Body Armor NIJ Standard 0115.00, using a P1 knife

The results are also shown in Table 2 below.

### Example 14 (Comparative)

Panels of the same size as in Example 3 were produced and tested for knife stab protection. The panels were formed only with 9 layers of thin titanium film (0.127 mm thickness, from Deutsche Titan), without any fiber reinforcement.

The panels were tested for knife-blade stab resistance in accordance with the NIJ Stab Resistance of Personal Body Armor NIJ Standard 0115.00, using a P1 knife.

The results are also shown in Table 2 below.

TABLE 2

| Example | System Weight | Thickness | Impact | |
|---|---|---|---|---|
| Penetration | (psf) | (inches) | Energy (j) | (mm) |
| 8 | 1.65 | 0.254 | 36.20 | 18 |
| 9 | 1.68 | 0.255 | 36.28 | 25 |
| 10 | 1.35 | 0.198 | 36.14 | 03 |
| 11 | 1.41 | 0.230 | 36.00 | 17 |
| 12 | 1.39 | 0.182 | 35.82 | 30 |
| 13 (comparative) | 1.43 | 0.265 | 36.51 | 40 |
| 14 (comparative) | 0.88 | 0.042 | 36.06 | 55 |

It can be seen that the present invention provides composites and body armor that are resistant to knife stabs, ice pick stabs and/or ballistic projectiles. The composites are easy to manufacture and provide desirable protection to the wearer.

The above examples demonstrate the knife resistance performance as per energy level E2 and protection level 1, specified by the NIJ standard 0115.00 for flexible vest constructions. Vest material formed only from high tenacity fibers (Comparative Example 13) had good ballistic resistance but poor knife resistance. The use of only 3 layers of thin titanium film in reinforced form with high tenacity fibers (Example 11) resulted in a material that achieved the desired knife resistance (spike penetration less than 20 mm) and pass the test. The addition of more layers of reinforced thin titanium (9 layers of RT1 in Example 10) provided the best penetration resistance. The addition of 5 layers of reinforced thin titanium film (including woven high tenacity fibers) to a vest material of only 19 layers (Example 8) also provided a composite material that had less than 20 mm spike penetration. Furthermore, it can be seen that the addition of 5 layers of a reinforced thin titanium film (including non-woven high tenacity fibers) to a vest material of only 19 layers (Example 9) significantly reduced the spike penetration when compared with a vest material that had 30 layers of only high tenacity fibers (Comparative Example 13). Likewise, it can be seen that the addition of 5 layers of thin titanium film to a vest material of only 19 layers (Example 12) also reduced the spike penetration when compared with a vest material that had 30 layers of the same high tenacity fibers (Comparative Example 13). Finally, it can be seen that the use of 9 layers of thin titanium film by itself (Comparative Example 14) had poor spike penetration resistance.

This invention, as summarized by the examples listed in Tables 1 and 2, thus demonstrates that flexible vests can achieve both ice-pick and knife protection using flexible reinforced titanium film.

Having thus described the invention in rather full detail, it will be understood that such detail need not be strictly adhered to but that further changes and modifications may suggest themselves to one skilled in the art, all falling within the scope of the invention as defined by the subjoined claims.

1-38. (canceled)

39. An impact resistant composite, said composite comprising: at least one laminate layer comprising a first thermoplastic film having first and second surfaces; a first fibrous layer having first and second surfaces and comprising high tenacity and attached via its first surface to the first surface of said first thermoplastic film; a layer of thin titanium film having first and second surfaces, and having a thickness of from about 0.05 to about 0.35 mm; a first adhesive layer attaching the first surface of said titanium film to the second surface of said first fibrous layer; a second fibrous layer having first and second surfaces and comprising high tenacity fibers; a second adhesive layer attaching said first surface of said second fibrous layer to said second surface of said titanium film, and a second thermoplastic film having first and second surfaces and being attached to said second surface of said second fibrous layer, the composite being resistant to at least one of knife stabs, ice pick stabs and ballistic projectiles.

40. The composite of claim 39 wherein the thickness of said titanium film is from about 0.1 to about 0.2 mm.

41. The composite of claim 40 wherein said high tenacity fibers comprise high molecular weight polyethylene fibers.

42. The composite of claim 39 wherein said composite comprises a plurality of said laminate layers that are stacked together.

43. The composite of claim 39 wherein said first and second thermoplastic film s comprise linear low density polyethylene films.

44. The composite of claim 39 wherein said high tenacity fibers have a tenacity of at least about 30 grams per denier.

45. The composite of claim 39 wherein at least about 50 percent by weight of the fibers in said fibrous layers comprise said high tenacity fibers.

46. The composite of claim 39 wherein said high tenacity fibers are selected from the group consisting of high molecular weight polyethylene, high molecular weight polypropylene, aramid, polyvinyl alcohol, polyacrylonitrile, polybenzazole, polyester and rigid rod fibers and blends thereof.

47. The composite of claim 39 wherein said high tenacity fibers are selected from the group consisting of high molecular weight polyethylene, aramid and blends thereof.

48. The composite of claim 39 wherein said high tenacity fibers comprise high molecular weight polyethylene.

49. The composite of claim 39 wherein said first and second fibrous layers are selected from the group consisting of woven fabrics, non-woven fabrics and knitted fabrics.

50. The composite of claim 39 wherein said first arid second fibrous layers are in the form of a non-woven fabric.

51. The composite of claim 50 wherein said fibrous layers comprise unidirectionally oriented fibrous layers.

52. The composite of claim 51 wherein adjacent fibrous layers are oriented 0°/90° relative to one another.

53. The composite of claim 39 wherein said first and second fibrous layers are in the form of a woven fabric.

54. The composite of claim 39 wherein said composite is resistant to knife stabs.

55. The composite of claim 39 wherein said composite is resistant to ice pick stabs.

56. The composite of claim 39 wherein said composite is resistant to ballistic projectiles.

57. The composite of claim 42 wherein said high tenacity fibers comprise high molecular weight polyethylene fibers.

58. The composite of claim 42 wherein said composite further comprises at least one additional fibrous layer attached to said plurality of laminate layers, said additional fibrous layer comprising high tenacity fibers.

59. The composite of claim 58 wherein said fibers of said first and second fibrous layers comprise high molecular weight polyethylene and said fibers of said additional fibrous layers comprise aramid.

60. The composite of claim 39 wherein said composite has an ice pick penetration when tested in accordance with the NIJ Stab Resistance of Personal Body Armor test standard NIJ-STD-0115.00 of 20 mm or less.

61. The composite of claim 39 wherein said composite has a knife-stab penetration when tested in accordance with the NU Stab Resistance of Personal Body Armor test standard NU-STD-0115.00 using a P1 knife of 20 mm or less.

62. An impact resistant composite, comprising:
(a) a plurality of fibrous layers, each of the fibrous layers comprising a network of high tenacity fibers, and
(b) at least one layer of a thin titanium film, said titanium film having a thickness of from about 0.05 to about 0.35 mm, said titanium film being disposed between at least two adjacent fibrous layers, the composite being resistant to at least one of knife stabs, ice pick stabs and ballistic projectiles.

63. The composite of claim 64 wherein said titanium film has a thickness of from about 0.1 to about 0.2 mm.

64. The composite of claim 62 wherein said high tenacity fibers are selected from the group consisting of high molecular weight polyethylene, high molecular weight polypropylene, aramid, polyvinyl alcohol, polyacrylonitrile, polybenzazole, polyester and rigid rod fibers and blends thereof.

65. The composite of claim 62 wherein said high tenacity fibers are selected from the group consisting of high molecular weight polyethylene, aramid and blends thereof.

66. The composite of claim 62 wherein said high tenacity fibers comprise high molecular weight polyethylene.

67. The composite of claim 62 including at least one second layer of a thin titanium film, said second titanium film having a thickness of from about 0.05 to about 0.35 mm, said second titanium film overlying one of said plurality of fibrous layers, and at least one additional fibrous layer overlying said second titanium film layer, said additional fibrous layer comprising a network of high tenacity fibers.

68. Body armor which is resistant to at least one of knife stabs, ice pick stabs and ballistic projectiles, said body armor comprising at least one composite, the composite comprising at least one layer of the composite of claim 39.

69. The body armor of claim 68 wherein the thickness of said titanium film is from about 0.1 to about 0.2 mm.

70. The body armor of claim 69 wherein said high tenacity fibers comprise high molecular weight polyethylene fibers.

71. The body armor of claim 68 wherein said fibrous layers are in the form of a non-wove fabric.

72. The body armor of claim 68 wherein said fibrous layers ate in the form of a woven fabric.

73. The body armor of claim 39 which is resistant to knife stabs, ice pick stabs and ballistic projectiles.

74. Body armor which is resistant to at least one of knife stabs, ice pick stabs and ballistic projectiles, said body armor comprising at least one composite, the composite comprising said composite of claim 42.

75. Body armor which is resistant to at least one of knife stabs, ice pick stabs and ballistic projectiles, said body armor comprising at least one composite, the composite comprising said composite of claim 58.
